(19) United States
(12) Patent Application Publication
(10) Pub. No.: US 2001/0039519 A1
(43) Pub. Date: Nov. 8, 2001

(54) Cooperative buying system for purchasing consumer products using a computer network

(76) Inventor: David John Richards, Salem, NH (US)

Correspondence Address: David John Richards, 77 Lake Shore Road, Salem, NH, 03079-1975, US

(21) Appl. No.: 09/799,711

(22) Filed: Mar. 7, 2001

Related U.S. Application Data
(60) Provisional application No. 60/187,831, filed on Mar. 8, 2000.

(51) Int. Cl. G06F 17/60

(52) U.S. Cl. 705/27

(57) ABSTRACT

A system, method and apparatus that provides buying information and recommendations to help consumers purchase products from retail merchants when prices are at their lowest relative point rather than when the consumer runs out and needs to purchase at a higher price. The system provides electronic access to a plurality of product information from a plurality of retail merchants in a plurality of markets. For each regularly purchased product the system displays the lowest price available from a plurality of retail merchants. It also displays a price index that indicates how the current lowest price compares with the high and low price recorded for the product over a defined period of time, a re-order index that forecasts when the consumer is expected to run out of the product and a unit price index that indicates how the current unit price compares with the unit prices of a group of similar products. Using the price, re-order and unit price index information the system recommends products that the consumer should consider purchasing. For products purchased from retail merchants with physical stores the system will create a shopping list for each store listing the products in order of location in the physical store for quick purchase. Finally, the system provides a cooperative price check and update function where some consumers, who are also members, check and update prices and store location information on a defined number of products during their regular shopping trip and share this information with the larger consumer population.

### CROSS-REFERENCE TO RELATED APPLICATIONS

This application claims benefit of provisional application No. 60/187,831, filed Mar. 8, 2000.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates generally to the use of computer networks (such as the Internet) for on-line shopping of consumer products. The present invention more specifically relates to a cooperative networked electronic shopping system that provides consumers with buying and purchase recommendation information to help them shop more effectively and therefore get the best value for their money.

2. Description of Background Art

Purchase of consumable products like food, household supplies, personal and pet care products consumes a significant percentage of a household's income. To minimize this weekly expense, consumers will look for ways to obtain the highest quality products at the lowest possible price.

Effective comparison shopping for consumable products is not a simple task since numerous products are purchased each week and many products are available in several competing retail merchant stores with different prices that are constantly changing. Demand for consumable products typically exists when the consumer runs out of the product. Once demand exists, the consumer is usually looking to satisfy that demand as quickly as possible with as little effort as possible.

Retail merchants offer weekly advertised specials at reduced prices to draw consumers into their stores hoping consumers will purchase the remaining items on their shopping list at higher prices. Many advertised items are actually not on sale or only discounted slightly. Wholesale clubs claim to have the lowest prices yet some items may be priced higher than supermarkets.

Consumers can save significant money on consumable products if they could purchase products when prices were at their lowest relative point rather than when they run out and therefore need to purchase at a higher price. To achieve this, the consumer would need to know the lowest price from all available retail merchants for each product on their shopping list. Having this information would allow the consumer to purchase products at the retail merchant with the lowest price. The consumer would also need to know how the current lowest price available compares to the high and low price recorded for the product over a defined period of time. Having this information would allow the consumer to gauge the relative price of the product. The consumer would also need to know how often the product reaches the lowest price recorded. Having this information would allow the consumer to determine the probability of this product achieving the lowest price before the consumer runs out of the product. The consumer would also need to know how the products current unit price compares with current unit prices of similar products. Having this information would allow the consumer to determine the value of this product compared to same products with different sizes or products with different brands. Finally, the consumer will need to forecast when they expect to run out of the product. Having this information would allow the consumer to determine how long they could wait for a lower price. Using this information, purchase recommendations could then be made allowing the consumer to save money.

The current state of art would require that consumers spend an enormous amount of time collecting, analyzing and recording price information online and offline. It would also require that consumers manually keep track of when they expect to run out of products.

There thus exists a need in the art for an improved system that provides buying information and recommendations to help consumers purchase products from retail merchants when prices are at their lowest relative point rather than when the consumer runs out and needs to purchase at a higher price.

The following U.S. patent references are cited:

1. U.S. Pat. No. 5,970,469, issued Oct. 19, 1999, to Scroggie, et al.

2. U.S. Pat. No. 5,950,173, issued Sep. 7, 1999, to Perkowski

3. U.S. Pat. No. 6,009,413, issued on Dec. 28, 1999 to Webber, et al.

The following other references are cited:

1. “Food fight”, Consumer Reports, pp. 11-17, Sep. 2000

### BRIEF SUMMARY OF THE INVENTION

One object of this invention is to provide an improved electronic shopping system, method and apparatus that provides buying information and purchasing recommendations to help consumers purchase products from retail merchants when prices are at their lowest relative point typically resulting in significant cost savings.

Briefly, and in general terms, the system comprises a sequence of steps performed at a central computer (Server) in cooperation with a plurality of remotely located consumer's computers (Clients) over a communications network such as the (Internet). The system provides the capability to log-in as a registered consumer. The capability to display on the client and store on the server a plurality of product information including the lowest retail price available for each product offered by a plurality of retail merchants in each market and sorting this information in order of recommended purchase. The capability to locate products by department and category or by searching for a product by keywords. The capability to create a list of regularly purchased products selected by each registered consumer and sorted in order of recommended purchase. The capability to create a list of products selected for purchase by the registered consumer. The capability to summarize the products selected for purchase for each retail merchant available in the market by displaying the total products recommended to be purchased at this retail store and the total savings that can be realized by purchasing these products at this retail store. The capability to temporarily de-activate retail merchants and some departments whereby products are then moved to the remaining active retail merchants based on the next lowest price for each product. The capability to create store shopping lists whereby the products in the list of products selected for purchase are sorted by each retail merchant and listed in order of physical store location.

An aspect of this invention is to provide a method and apparatus to automatically display the lowest product price for a plurality of products from a plurality of retail merchants where the consumer defines the selection of retail merchants.

Another aspect of this invention is to provide a method and apparatus that creates, stores and displays a price index for each product within a plurality of products. Where the price index provides an indication of how the current lowest price available from a plurality of retail merchants compares with the high and low prices recorded for this product over a defined period of time.

Another aspect of this invention is to provide a method and apparatus that creates, stores and displays price history information for each product within a plurality of products. Where the price history graphically displays the price levels over time.

Another aspect of this invention is to provide a method and apparatus that creates, stores and displays a personalized re-order index for each product within a plurality of products. Where the re-order index provides an indication of how much time is remaining before the consumer will need to purchase the product.

Another aspect of this invention is to provide a method and apparatus that creates, stores and displays a unit price index for each product within a plurality of products. Where the unit price index provides an indication of how the current unit price compares with the unit prices of a group of similar products.

Another aspect of this invention is to provide a method and apparatus where a plurality of products for each registered consumer are recommended for purchase based on the consumers shopping list, price index, re-order index and unit price index information.

Another aspect of this invention is to provide a method and apparatus where a plurality of products in a plurality of product categories are recommended for purchase based on the consumers shopping list, price index, re-order index and unit price index information.

Another object of this invention is to provide consumers with a cooperative electronic shopping and pricing system that provides consumers who are also members with the ability to input pricing information on products and share this pricing information with the larger consumer population. This system provides the capability to automatically include in each store list a defined number of products that require price checks for consumers who are also members. Selection of products that require price checks is based on previous price check date, product order frequency and price change frequency. The capability for members to update the store lists with product price and location information. The capability for members to update pricing based on prices advertised by retail merchants.

Another aspect of this invention is to provide a method and apparatus that allows a registered consumer to view and edit the products in the retail merchant list. Each retail merchant registered in the market is listed along with the total number of products selected for purchase and resulting cost savings for the consumer.

Another aspect of this invention is to provide a method and apparatus where registered consumers who are also members can add modify and delete retail stores.

### BRIEF DESCRIPTION OF THE SEVERAL VIEWS OF THE DRAWING

FIG. 1 is an overall process flow of the system of the invention

FIG. 2 is an overall software process flow diagram of the system of the invention

FIG. 3 defines the software flow diagram for the Sign-In function

FIG. 4 defines the software flow diagram for the Main Menu function

FIG. 5 defines the flow diagram for the Search function

FIG. 6 defines the flow diagram for the Home Page function

FIG. 7 defines the flow diagram for the Price History function

FIG. 8 defines the flow diagram for the Current List function

FIG. 9 defines the flow diagram for the My Shopping List function

FIG. 10 defines the flow diagram for the List Totals function

FIG. 11 defines the flow diagram for the Category List function

FIG. 12 defines the flow diagram for the Browse function

FIG. 13 defines the flow diagram for the Browse List function

FIG. 14 defines the flow diagram for the Product List function

FIG. 15 defines the flow diagram for the Shopping List fiction

FIG. 16 defines the flow diagram for the Product Information function

FIG. 17 defines the flow diagram for the Compare List function

FIG. 18 defines the flow diagram for the Coupon List function

FIG. 19 defines the flow diagram for the Retail Merchant List function

FIG. 20 defines the flow diagram for the Store List function

FIG. 21 defines the flow diagram for the Office Menu function

FIG. 22 defines the flow diagram for the Weekly Circular function

FIG. 23 defines the flow diagram for the Store Aisles function

FIG. 24 defines the flow diagram for the Store Location function

FIG. 25 defines the flow diagram for the Weekly Coupon function

### DETAILED DESCRIPTION OF THE INVENTION

The present invention is a cooperative consumer electronic shopping system that provides consumers with electronic access to a plurality of product and pricing information from a plurality of retail merchants in a plurality of markets. It provides consumers with information and recommendations that will allow them to purchase products when prices are at their lowest relative point resulting in significant cost savings. It provides physical store routing information that allows a consumer to quickly locate products in each retail store reducing the amount of shopping time. The present invention is also a cooperative consumer electronic shopping and pricing system that provides consumers with the ability to input pricing information on products and share this pricing information with the larger consumer population.

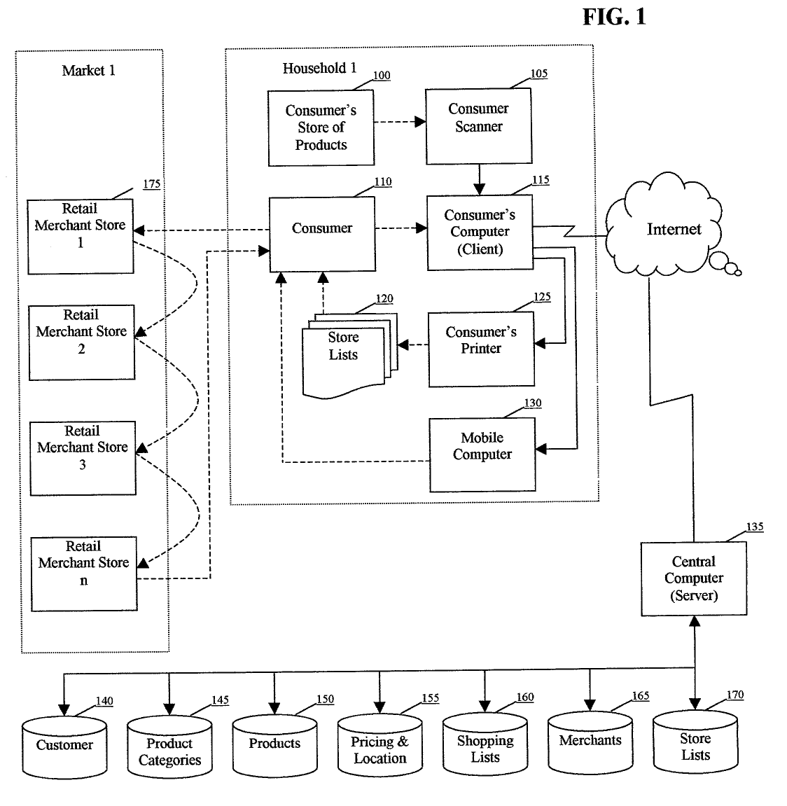

FIG. 1 defines the overall process of the invention. In the first embodiment of the invention, a consumer, typically in the home, uses a computer (115), further referred to herein as the client to connect to a central server (135) using a computer network (such as the Internet). After logging-in as a customer (140), the client can drill down product categories (145) to locate products (150,155) they frequently purchase, browse through product categories where the top product purchase recommendations for each category will be displayed or search for a product that is required.

For each product listed, the system will provide information and recommendations on products to help consumer's buy when prices are at their lowest relative point rather than when they run out and need to purchase at a higher price. For each product listed, the lowest price available from multiple retail merchant stores will be displayed. A price index will be displayed that indicates how the current lowest price compares to the high and low prices recorded over a defined period of time. A re-order index will be displayed that forecasts when the consumer is expected to run out of the product and therefore need to repurchase. A unit price index will also be displayed that indicates how the product's unit price compares to unit prices of other similar products. Using the price, re-order and unit price indexes the system will recommend products that should be considered for purchase before a consumer runs out and needs to purchase at a higher price.

On some products the system will allow the consumer to list and compare similar products in order of unit price to help the consumer find the product with the lowest unit price. On some products an icon will be displayed that indicates a product coupon is available for the product and will allow the consumer to list all products associated with the coupon.

Consumers select products they frequently purchase and place them into a personalized shopping list (160) that will be saved for each consumer. As buying decisions are made the consumer selects products from the shopping list to be purchased. When the consumer is ready to purchase the products, the system will provide a merchant list (165) that will list each retail merchants store, the total number of products that are recommended to be purchased at this store and the total savings that will be realized if the products are purchased at this store. If the savings for a given store are not worth the added shopping time the store can be removed and the products recommended to be purchased at this store will be automatically moved to remaining active stores based on the store with the next lowest price.

When the consumer is satisfied with the merchant list, the system will automatically create store lists (170), de-select the products from the consumers shopping list and calculate the re-order period and index for each product that is purchased. The store list displays a separate list of products for each store. Each store list will sort the items based on the physical route within the store. Using the consumer's printer (125) connected to the client computer the consumer prints the store lists (120) and shops at each retail merchant's store (175) to obtain the products required.

Some percentage of consumers will also verify prices. For these consumer's the server will automatically add additional products to the store lists that require price verification As these consumer's shop for their products in the retail merchants store they will verify the prices of products they are purchasing as well as products added for price verification only. After the products have been purchased the consumer will connect to the central server and update any prices that have changed. Some percentage of consumers will also have an additional responsibility to update pricing based on retail merchant's advertised specials (weekly circulars).

Some products (mainly perishable products) require purchase every week. As these products are consumed during the week the consumer will be able to quickly locate the product in their shopping list and select it for purchase.

In a second embodiment of this invention a scanner (105) connected to the client computer (115) is used to scan the UPC (Universal Product Code) labels of the products stored in their home (100). The client automatically sends the UPC information to the server, and the server automatically creates a personalized shopping list for the consumer. The scanner is also used to scan the UPC labels of products consumed during the week that require replenishment. The client will automatically locate the product in their shopping list and select it for purchase.

In a third embodiment of this invention a mobile computer (130) is connected to the client computer (115) eliminating the need for the printer (125) and store lists (120) if desired. The mobile computer is used to store the consumer's shopping list and the store lists. For consumers who are verifying prices the mobile computer allows the consumer to verify prices and immediately update prices while shopping in the merchant's store. The price total for all products in the store list can be compared against the retail merchants register total to immediately identify and correct any price discrepancies.

In a forth embodiment of this invention the client computer (115) is mobile eliminating the need for a second mobile computer (130), a printer (125) and store lists (120) if desired. For consumers who are verifying prices the mobile computer allows the consumer to verify prices and immediately update prices while shopping in the merchant's store. The price total for all products in the store list can be compared against the retail merchants register total to immediately identify and correct any price discrepancies.

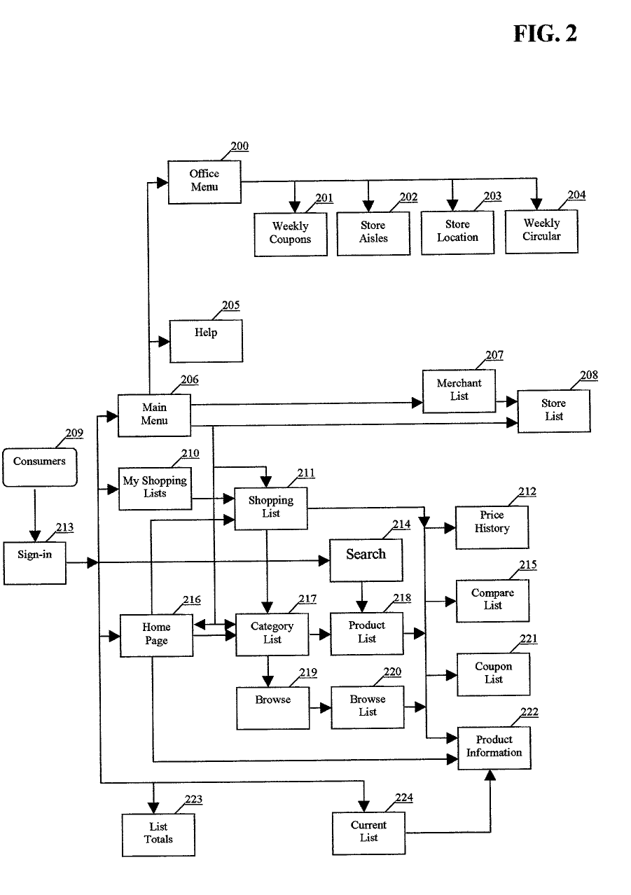

FIG. 2 provides a flow diagram of the software system. Using a client computer, consumer's (209) connect to the central server and Sign-in (213). Once confirmed as a registered consumer the main menu (206), home page (216), search (214), current list (224), my shopping lists (210) and list totals (223) are displayed. Using the main menu the consumer can shop by category (217), access their selected shopping list (211), access the current store lists (208), change market settings (207), access help (205) and access the office menu (200-204) (if permission exists). The consumer can directly search (214) for a product by entering a search word. My shopping lists (210) will allow the customer to select one of many shopping lists (211) for display. The consumer would typically go to their shopping list (211) and select items for purchase. The consumer may then elect to enable the browse (219) and browse list (220) function to check out top product recommendations that are available in certain product categories and place selected items into their shopping list (211). The category list (217) can also be used to drill down to a specific product category and then use the product list (218) to display the list of products in the selected category. If further detail information is required on a product, the product information (222) function could be accessed. If the consumer desires to compare unit prices of similar products the compare list (215) function could be accessed. If the consumer desires to view coupon details and list associated valid products the coupon list (221) function could be accessed. The product information, compare list and coupon list functions can be accessed from the home page (216), shopping list (211), browse list (220) or product list (218). Once the consumer has completed selecting products the merchant list (207) will be displayed allowing the consumer to remove one or more retail merchant stores if they prefer and then create store lists (208).

After products are purchased and if the consumer is a member and therefore verifying prices the consumer will again connect to the central server and Sign-In (213). The consumer would then select the store list (208) and update pricing and store aisle location information on the products that required updating.

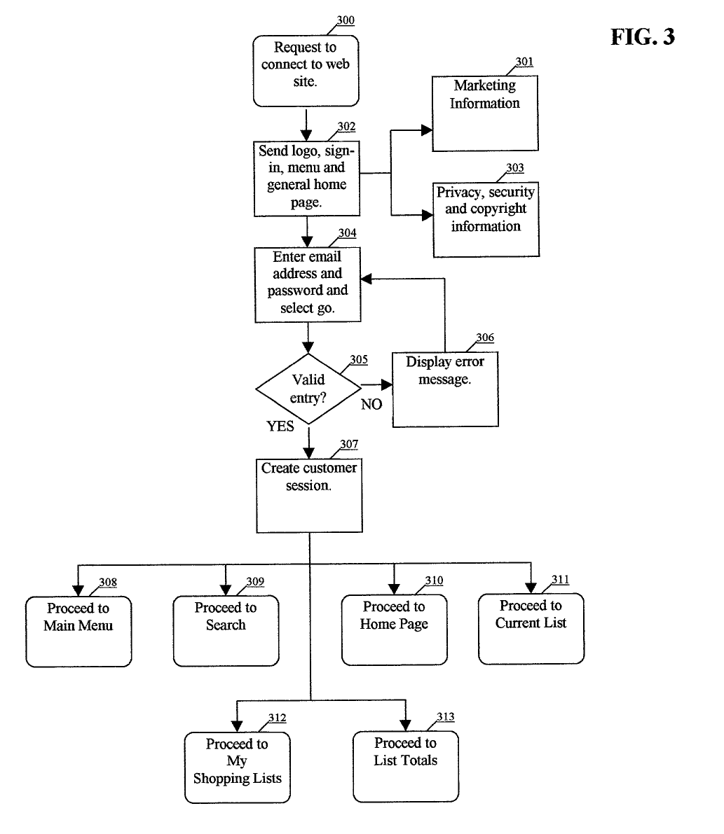

FIG. 3 defines the flow diagram for the Sign-In step. The customer first sends a request to connect to the central server (300). The server responds by sending logo, sign-in, menu and the general home page information to the client (302). If the consumer needs information about the service the consumer can select (click on) the marketing information icons (301) or the privacy, security or copyright links (303). If the consumer elects to sign-in they would then enter their last name and password and select (click on) the “GO” icon (304). The consumer's identity information is sent to the server, the server checks that the entry is valid (305). If the entry is not valid a message will be returned to the client indicating the error (306). If the entry is valid the server will create a new customer session (307) and send the Main Menu (308), Search (309), Home Page (310), Current List (311), My Shopping Lists (312) and List Total (313) information to the client

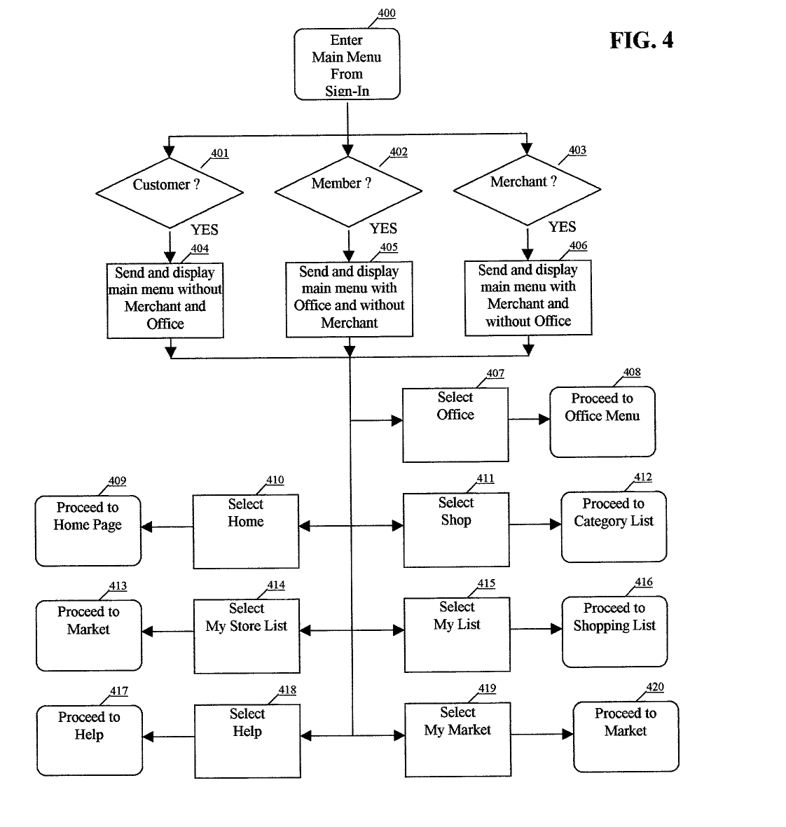

FIG. 4 defines the flow diagram for the Main Menu Step. The Main Menu is entered from the Sign-In function (400). The server will check to determine if the user is a consumer (401), member (402), or merchant (403). If the user is a consumer the main menu information without Office and Merchant selections will be sent to the client (404). If the user is a member, the main menu information with Office and without Merchant selections will be sent to the client (405). If the user is a merchant, the main menu information with out Office and with Merchant selections will be sent to the client (406). Selecting Home (410) would instruct the server to send the home page to the client (409). Selecting Shop (411) would instruct the server to send a list of product categories to the client (412). Selecting My Store List (414) would instruct the server to send a list of retail merchants selected by the consumer, the total number of products that are recommended to be purchased at each store and the total savings that will be realized if the products are purchased at this store (413). Selecting My List (415) would instruct the server to send the customers selected shopping list (416) to the client. Selecting Help (418) would instruct the server to send help information to the client (417). Selecting Office (407) would instruct the server to send the office menu to the client (408).

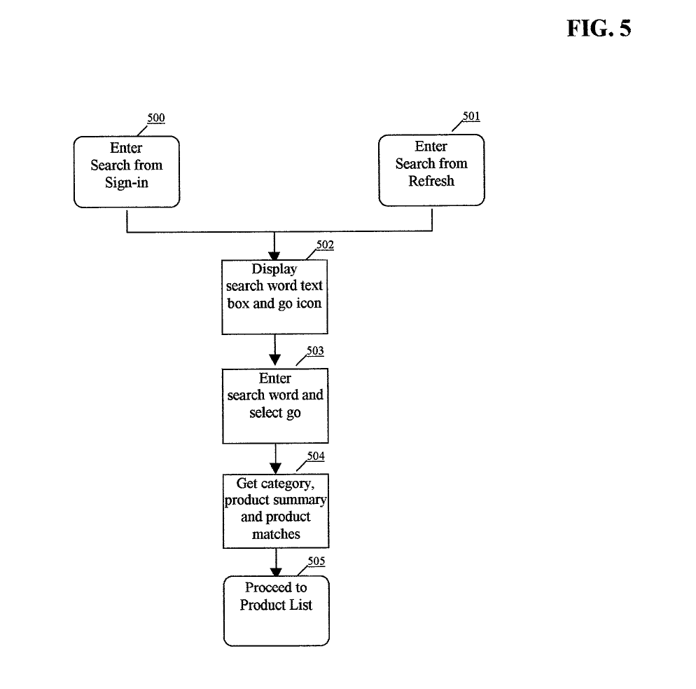

FIG. 5 defines the flow diagram for the Search function. Search allows consumers to locate products by matching product descriptions or category descriptions to a word or words entered by the consumer. The Search function is entered from the Sign-In function (500) or a client refresh (501) and sends and displays a search word text box and go icon (502). The consumer enters the product search information and selects the “GO” icon (503). The search information is sent to the server. The server will query the product database for matches to the search information (504) and a list of products will be displayed using the Product List function (505).

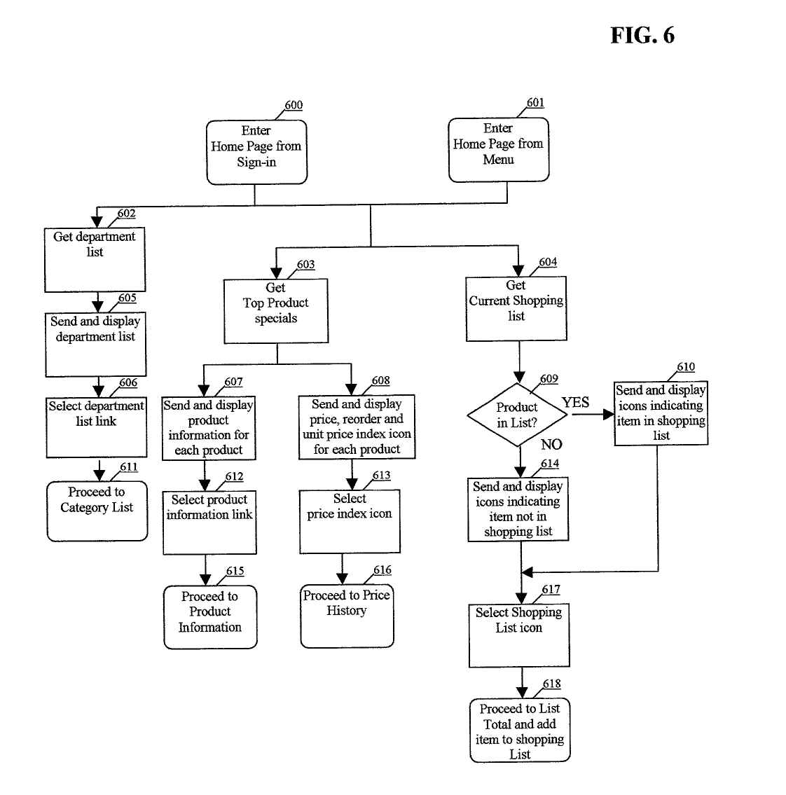

FIG. 6 defines the flow for the Home Page function. The Home Page function can be entered from Sign-In (600) or from the Main Menu (601). The server will query the database for the department list (602), the consumers shopping list (604) and the top product purchase recommendations in the database (603) based on price/re-order/unit price index listing any items that are in the consumer's shopping list first. This information will be sent and displayed on the client's computer (605,607,608). Selecting a department link (606) will invoke the Category List function (611) and display the list of categories in the department

Each of the products listed will contain a product name, product size and product information icon (607). Selecting the product information link (612) will invoke the product information function (615) and display detail information about the specific product in question Each of the products listed will also contain a price index icon along with high and low price, reorder index icon along with number of days of supply remaining and unit price index icon along with high and low unit prices for similar products (608).

The price index icon provides a visual indication of how the current price compares to the high and low prices for this product over a defined period of time. One method of calculating the price index for each product is as follows:

$$Price Index = 10 \times [ \frac{Recorded High Price - Current Price}{Recorded High Price - Recorded Low Price} ]$$

A price index of ten (10) indicates the lowest relative price for the product over the defied period of time and a price index of zero (0) indicates the highest relative price for the product over the defined period of time. In the preferred embodiment there are ten price index icons that will visually display the price indexes from 10 (best value) to 0 (worst value). Selecting the price index icon (613) will then invoke the price history function (616).

The re-order index icon provides a visual indication of how much time remains before the consumer will run out of the product. One method of calculating the re-order index for each product is as follows:

$$Re \text{-} Order Index = 10 \times [ \frac{Number of days since last purchase date}{Product supply at last purchase date} \times \begin{matrix}Product Consumption Rate\end{matrix} ]$$

Where

$$Product Consumption Rate = \frac{Total quantity of product consumed}{Total number of days in consumption period}$$

And where

Product supply at last purchase date=(Product quantity of last purchase×Product size of last purchase)

A re-order index of zero (0) indicates that a supply of the product exists and the product does not need to be purchased. A re-order index of one (10) indicates that the product has been consumed and the product should be replenished. In the preferred embodiment there are ten re-order index icons that will visually display the re-order indexes from 0 (purchase not required) to 10 (purchase required).

The unit price index icon provides a visual indication of how the current unit price compares to the high and low prices for similar products. One method of calculating the unit price index for each product is as follows:

$$Unit Price Index = 10 \times [ \frac{Recorded High Unit Price - Current Unit Price}{Recorded High Unit Price - Recorded Low Unit Price} ]$$

A unit price index of ten (10) indicates the lowest relative unit price for the product compared to unit prices of similar products and a unit price index of zero (0) indicates the highest relative unit price for the product compared to unit prices of similar products. In the preferred embodiment there are ten unit price index icons that will visually display the unit price indexes from 10 (best value) to 0 (worst value).

For a given product available from multiple retail merchants the system will display only the lowest price available from the plurality of retail merchants. In the preferred embodiment this is accomplished by selecting all retail merchants that carry the product and order this list by retail price in ascending order and displaying the lowest price.

Two shopping list icons (610,614) will be displayed. The server will check to see if the product is in the consumers shopping list (609) and will change the icon displayed giving a visual indication to the consumer. Selecting the shopping list icon (617) will invoke the List Total function (618) and place the product into the currently selected shopping list. Both shopping list icons will add the item to the consumers shopping list however the second icon will also select it for purchase.

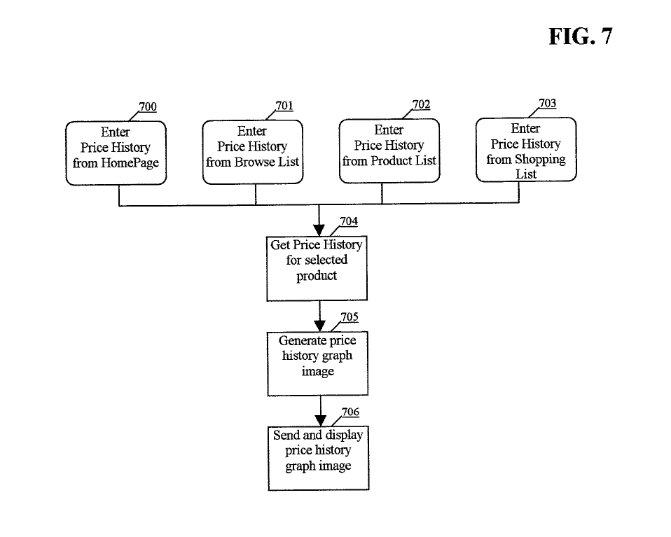

FIG. 7 defines the flow for the Price History function. This function can be entered from the Home Page (700), Browse List (701), Product List (702), and Shopping List (703) functions. This function gets the price history for the selected product (704), generates the image (705) and displays a graph of the recorded prices over a defined period of time (706). The “x” axis of the graph represents time and the “y” axis represents recorded price between the lowest recorded price and the highest recorded price. This function will provide the consumer an indication of how frequently the product achieves its lowest price.

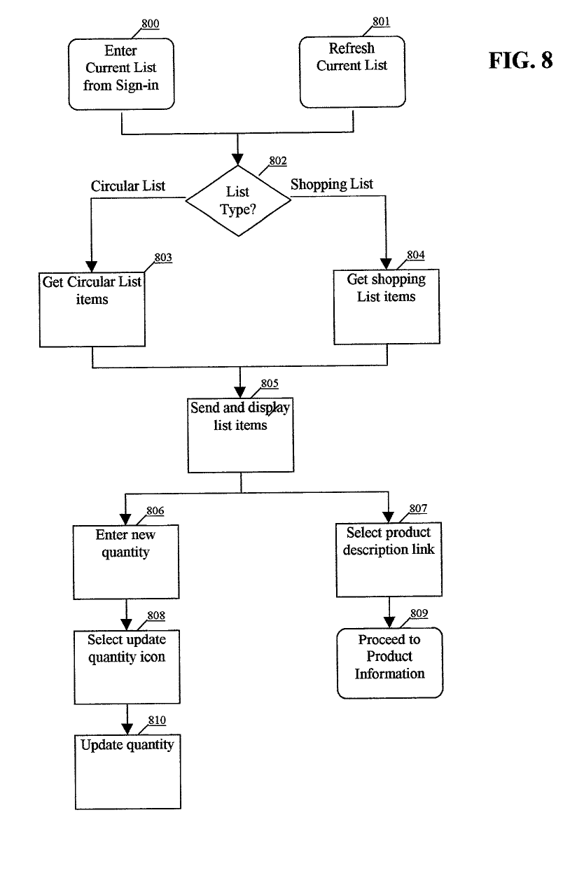

FIG. 8 defines the flow for the Current List function. This function is entered from Sign-In (800) or a client refresh (801) and will always displays the currently selected list. This function will display either a shopping list (default when entered from sign-in) or a circular list (if a member). The server will first check the consumer's session to determine the selected list (802) and then will query the database to obtain the list of products in the list (803,804). The list of products will be sent to the client and displayed in order of when products were added to the list (805). The last product to be added to the list will contain a quantity text box and the product description link. Entering a different quantity in the text box (806) and selecting the update icon (808) will instruct the server to change the quantity to the new quantity (810). All remaining products will display the quantity and product description link. Selecting the product description link (807) will invoke the product information function (809) and display detail information about the product.

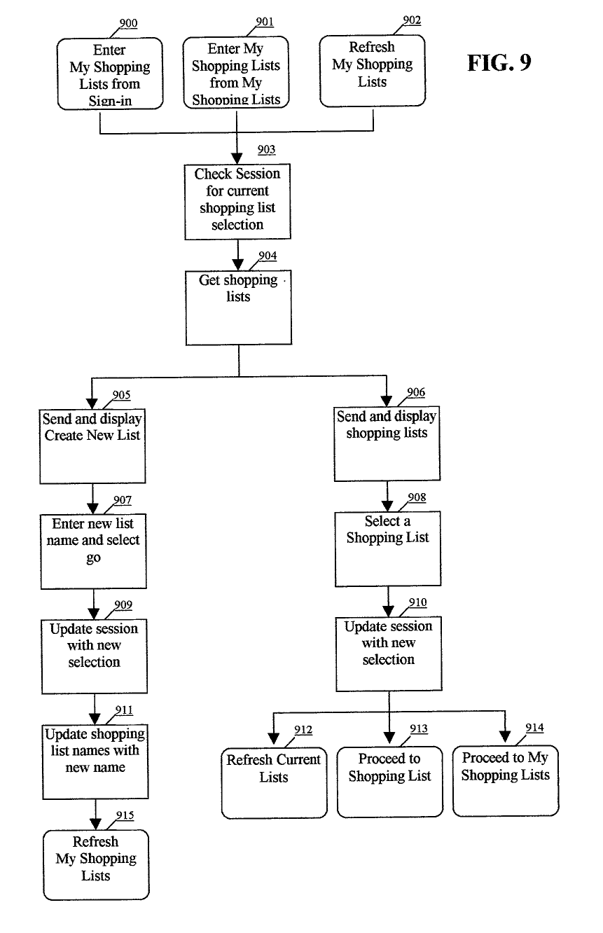

FIG. 9 defines the flow for My Shopping Lists function. This function allows the consumer to select one of several shopping lists from a drop down box. One list is standard and is the consumer-shopping list. The final selection is “Create New List” that allows the consumer to create personal lists for birthday's etc. This function is entered from sign-in (900), is invoked from itself when a new selection is made (901) and when a client refresh occurs (902). The server checks the consumer's session to determine what list is selected (903) and then query's the database to get the shopping list names (904) and sends this information to the client to be displayed (905,906). Selecting a new shopping list name (908) will instruct the server to update the session (910) and redisplay the list of shopping list names (914) (showing the list selected) and also instruct the server to display the selected list in the current list area (912). Selecting “Create New List” will instruct the server to send a new form to the client with a text box to enter a shopping list name. The consumer enters a new shopping list name and selects the GO icon (907). The client sends this information to the server and the server updates the database with this new name (911) and updates the session to indicate the new shopping list selection (909).

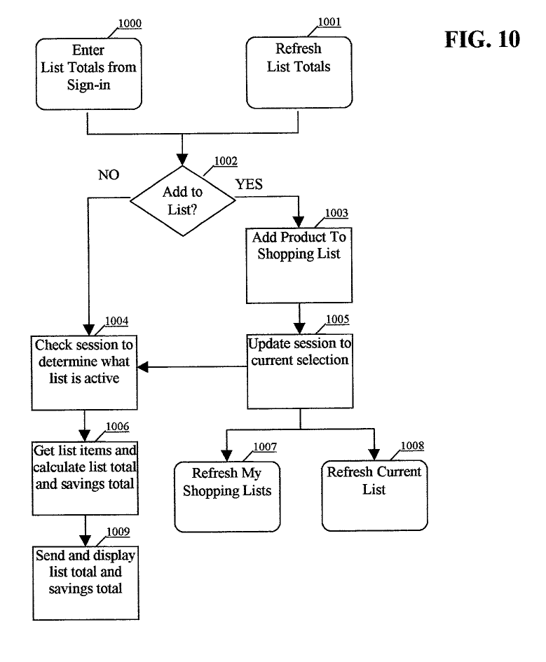

FIG. 10 defines the flow for the List Totals function. This function adds products to the consumers shopping lists and displays the list total and list savings of the currently selected list. This function is entered from Sign-In (1000) or from a client refresh (1001). This function first checks to see if a product is being added to a list (1002). If there is no product being added, the server will check the session to determine what session is active (1004) and then query the database to get the list of items (1006). The server will then calculate the total retail price of all items in the list and also calculate the total savings of all the items on the list (1006). This information is sent and displayed on the client computer (1009). Savings for each item are calculated by subtracting the current unit price of the item in the list from the unit price index high unit price multiplied by the quantity purchased and the product unit size. If there is a product being added, then the server will update the consumer's session to the selected list (1005) and then add the product information to the selected list (1004). The server will then refresh the current list (1008) and my shopping list (1007) functions so the added product will be displayed. The server will then calculate the list total and list savings (1006) and send this information be displayed on the client computer (1009).

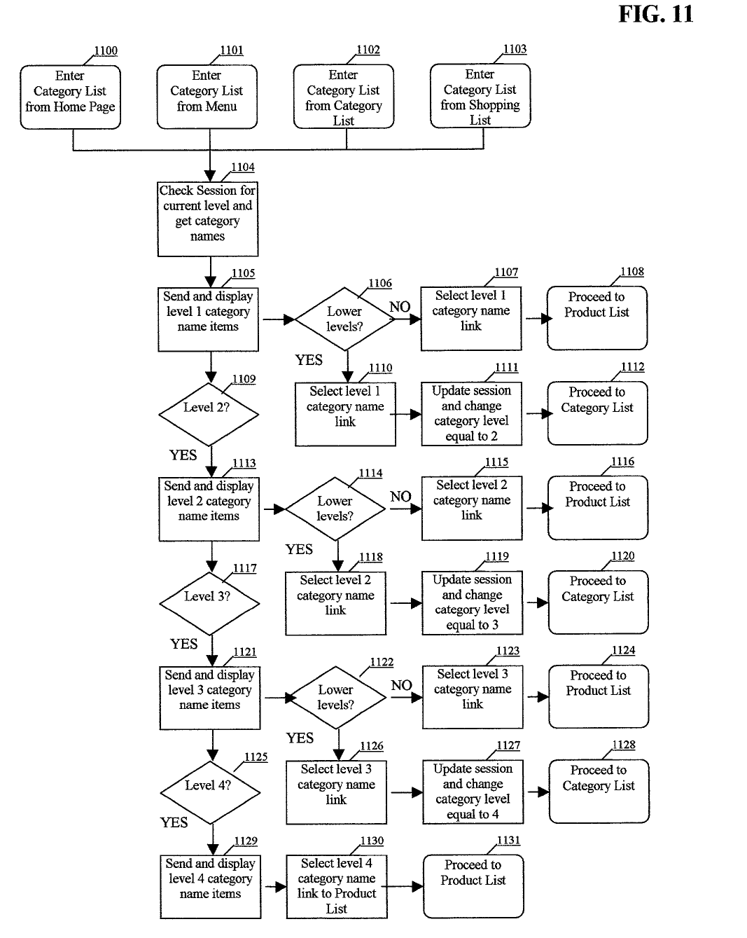

FIG. 11 defines the flow for the Category List function. This function displays a hierarchy of product categories to allow the consumer to drill down and locate products in a specific category. This function is entered from the Home Page (1100), Main Menu (1101), from itself (1102), or from Shopping List (1103). When this function is invoked the server will check the consumers session to determine current category level and will query the database to get the list of category names (1104). Level 1 category names (Product Departments) will always be displayed (1105). For each level 1 category name the server will then check to see if there are lower levels (1106). If there are no lower levels then selecting the category name link (1107) will invoke the Product List function to display the list of products in the selected category (1108). If there are lower levels then selecting the category name link (1110) will update the consumer's session to the next level (1111) and then invoke the Category List function to display the next level of category names (1112). Each category level will function the same as level 1 until level 4 is reached. Level 4 is the lowest level and all category name links will invoke the Product List function.

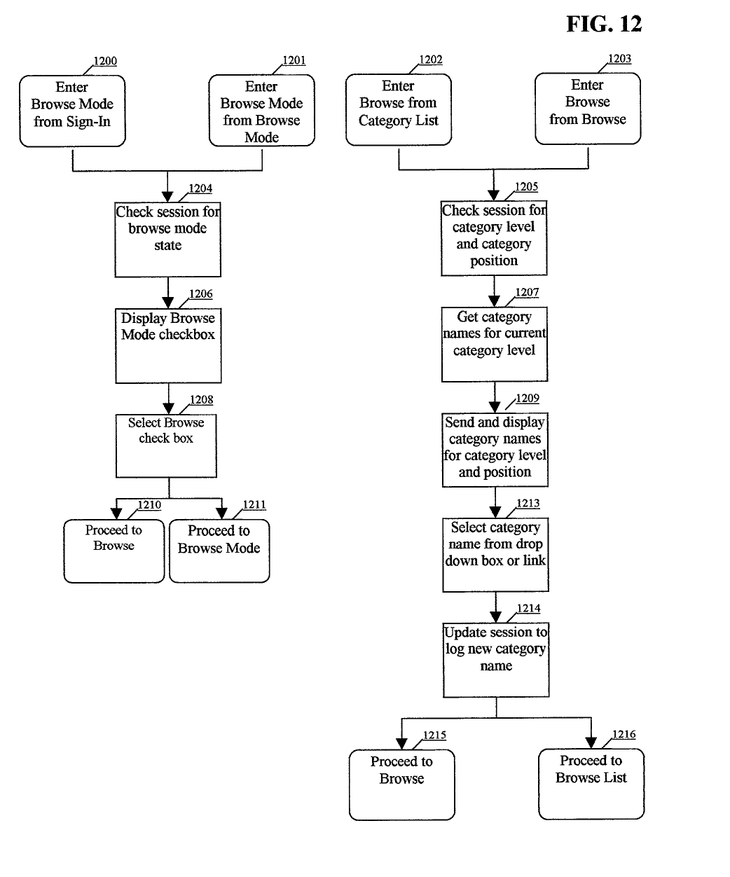

FIG. 12 defines the flow for the Browse Mode and Browse function. The Browse Mode function turns the Browse function on and off. The Browse function allows a consumer to browse through each category and display the top product purchase recommendations using the Browse List function. The Browse Mode function can be entered from Sign-In (1200) or from itself (1201). The server will check the session to determine browse mode state (1204) and then display the browse mode check box (1206). Selecting the browse check box (1208) will invoke the Browse (1210) and Browse Mode (1211) functions. The Browse function can be entered from Category List (1202) or from itself (Browse) (1203). When the client invokes this function the server will check the consumers session to determine the category level and the categories selected for each level (1205). The server will then query the database to get the list of the category names for the lowest category level (1207). The server will then send and display this information in the Browse frame (1209). The Browse display consists of a left, middle and right section. When the consumer enters the Browse function for the first time a drop down box containing all the category names are listed in the middle section with the first category name displayed in the drop down box. The right section contains the second category name link. The left section is blank. The consumer can select any category name from the drop down box or select the second category name link. Selecting a category name (1213) will update the consumer's session to log the new category name (1214). Next, the Browse function will be invoked to display the category selected in the drop down box in the middle section, display the previous category name in the left section and display the next category in the right section (1215). Finally the Browse List function will be invoked to display the top product purchase recommendations (best price and re-order index) for the category selected (1216).

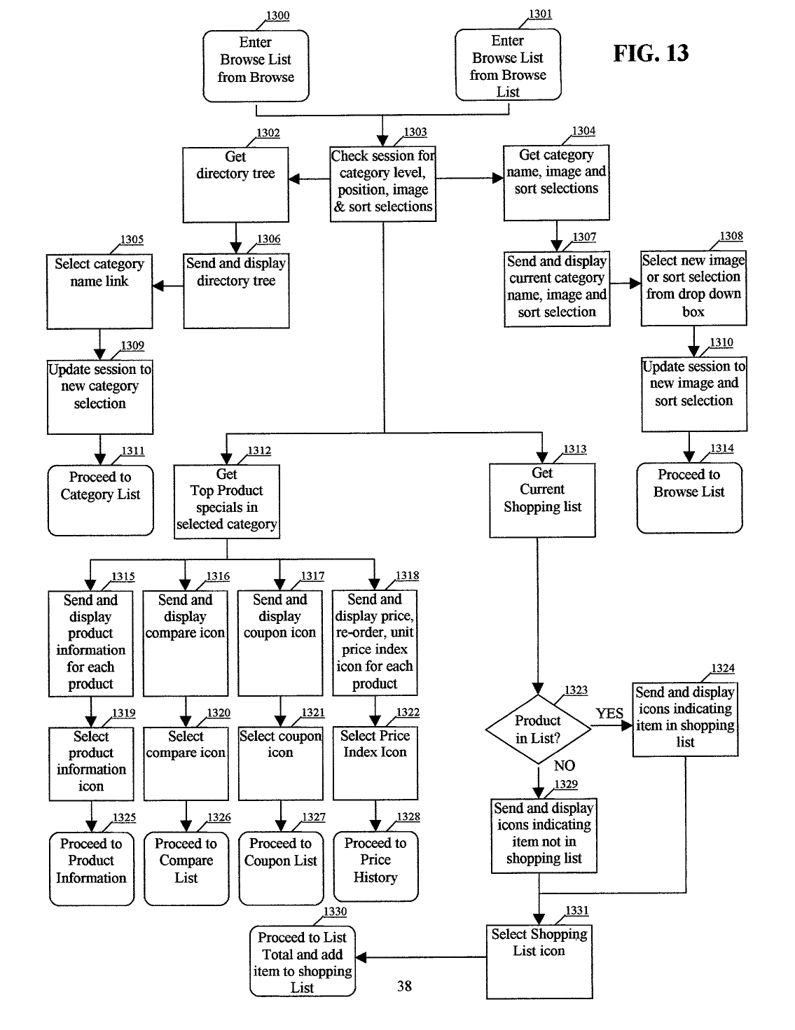

FIG. 13 defines the flow for the Browse List function. The Browse List function displays the top product purchase recommendations for the category level and category position selected. Purchase recommendations are provided by using the shopping list, price, re-order and unit price indexes. Two groups of products will be listed. Products in the consumers shopping list are listed first followed by any remaining products. Within each group, products with a price and unit price index of 10 are listed as “Best Buy”, products with a price and unit price index greater than 9 are listed as “Better Buy” and products with a price and unit price index greater that 8 are listed as “Good Buy”. Products are ordered by the re-order index from an index of 10 (no supply exists) to 0 (supply exists). The Browse List function can be entered from the Browse function (1300) or from itself (Browse List) (1301). When the client invokes the Browse List function the server will check the consumer's session to determine current category level, category position, image selection and sort selection (1303).

The server will query the database to get the directory tree (1302), category name, image selections and sort list and selection (1304), the top products in the selected category (1312), and the consumers shopping list products (1313). The server will then send and display the directory tree (1306), category name, image drop down box, sort drop down box (1307) and the top product recommendations (1312). For each product a product info icon, product name, product size, unit price, price, and two shopping list icons will be displayed (1315). For each product a compare list icon (1316) and a coupon list icon (1317) will be displayed. For each product a price index icon along with high price and low price, a reorder index icon along with days of supply remaining, a unit price index icon along with high unit price and low unit price will be displayed (1318). If the product is contained in any shopping list (1323) then the server will display an icon indicating that the item is in the list (1324) otherwise it will display an icon indicating it is not in the list (1329).

If the consumer selects a category name link in the directory tree (1305) then the consumer's session will be updated to log the new category selection (1309) and the Category List function will be invoked to display the list of categories (1311). If a new image or sort selection is made (1308) the server will update the session to record these selections (1310) and invoke the browse list to refresh the display with the new selections (1314). Changing the image selection will display no images, small images or large images for the top product recommendations. Changing the sort selection will sort the top product recommendations by best buys, price index, re-order index, unit price index, unit price and coupons. If the product info icon is selected (1319) the server will invoke the Product Information function to display detail information on the product (1325). Selecting the compare icon (1320) will invoke the Compare List function (1326). Selecting the coupon icon (1321) will invoke the coupon list function (1327). Selecting the price index icon (1322) will then invoke the price history function that will display a graph of price changes over time for the product (1328). If the shopping list icon is selected (1331) the server will invoke the List Total function to add the product to the currently selected shopping list (1330). Both shopping list icons will add the item to the consumers shopping list however the second icon will also select it for purchase.

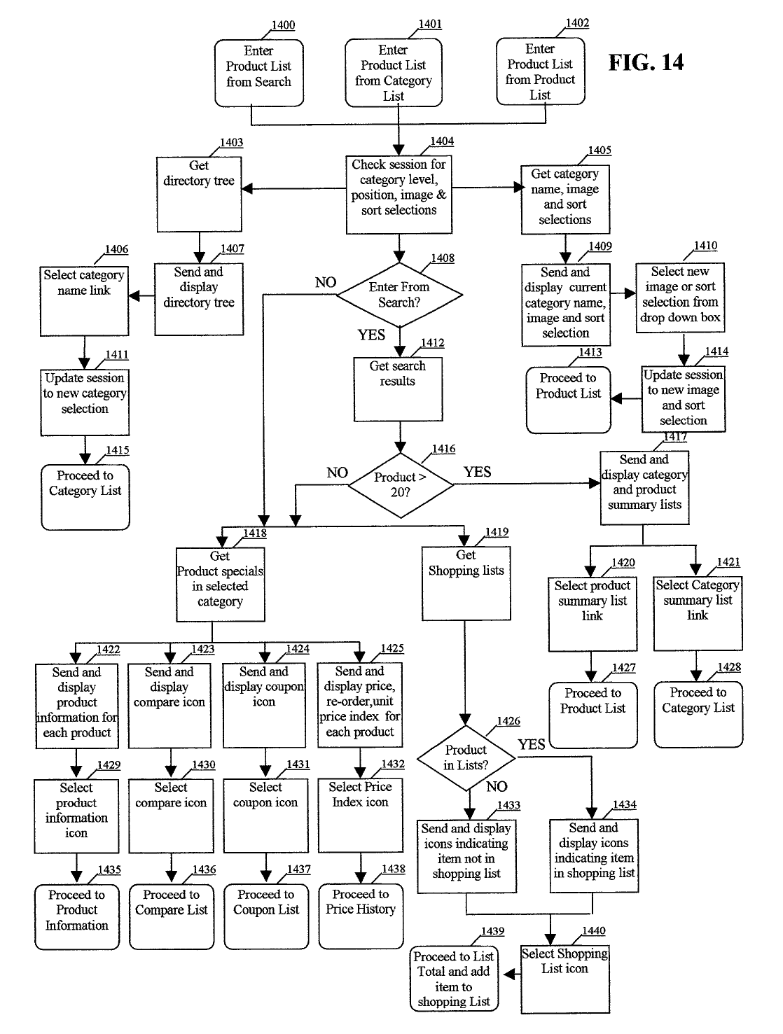

FIG. 14 defines the flow for the Product List function. The Product List function displays a list of products for the category or search word selected. The Product List function can be entered from the Category List function (1401), Search function (1400) or itself (Product List) (1402).

When the client invokes the Product List function the server will check the consumer's session to determine current category level, category position, image selection and sort selection (1404). The server will query the database to get the directory tree (1403), category name, image selections, sort list and selection (1405). The server will first check to determine if the entry point was from the Search function (1408). If the entry point was not the search function then the server will query the database to get the products in the selected category (1418), and the consumers shopping list products (1419). If the entry point was the Search function the server will query the database to get the results of the search (1412) and then check to see if the quantity of products is greater then 20 (1416). If the quantity is less than 20 then the server will query the database to get the products in the selected category (1418), and the consumers shopping list products (1419). If the quantity is greater than 20 then the server will query the database to get a category summary and product summary and send to the client (1417). The category summary will contain a list of categories that match the search word. The product summary will contain a list of categories containing products that match the search word along with the total number of products in the category. Selecting a category summary link (1421) will instruct the server to invoke the Category List function to display the category list (1428). Selecting a product summary link (1420) will instruct the server to invoke the Product List function. (1427)

If the consumer enters from the Category List function or enters from the Search Function with less than 20 products the server will then send and display the directory tree (1407), category name (or search word), image drop down box, sort drop down box (1409) and the list of products (1418). For each of the products a product info icon, product name, product size, unit price, price, and two shopping list icons will be displayed (1422). For each of the products a compare icon (1423) and coupon icon (1424) will be displayed. For each of the products a price index icon along with high and low price, a reorder index icon along with days of supply remaining, a unit price index icon along with high and low unit price will be displayed (1425). If the product is contained in any shopping list (1426) then the server will display an icon indicating that the item is in the list (1434) otherwise it will display an icon indicating it is not in the list (1433).

If the consumer selects a category name link in the directory tree (1406) then the consumer's session will be updated to log the new category selection (1411) and the Category List function will be invoked to display the list of categories (1415). If a new image or sort selection is made (1410) the server will update the session to record these selections (1414) and invoke the browse list to refresh the display with the new selections (1413). Changing the image selection will display no images, small images or large images for the list of products. Changing the sort selection will sort products by best buys, price index, re-order index, unit price index, unit price, brand, product name and several nutritional parameters. If the product info icon is selected (1429) the server will invoke the Product Information function to display detail information on the product (1435). Selecting the compare icon (1430) will invoke the Compare List function (1436). Selecting the coupon icon (1431) will invoke the Coupon List function (1437). Selecting the price index icon (1432) will then invoke the price history function that will display a graph of price changes over time for the product (1438). If the shopping list icon is selected (1440) the server will invoke the List Total function to add the product to the currently selected shopping list (1439). Both shopping list icons will add the item to the consumers shopping list however the second icon will also select it for purchase.

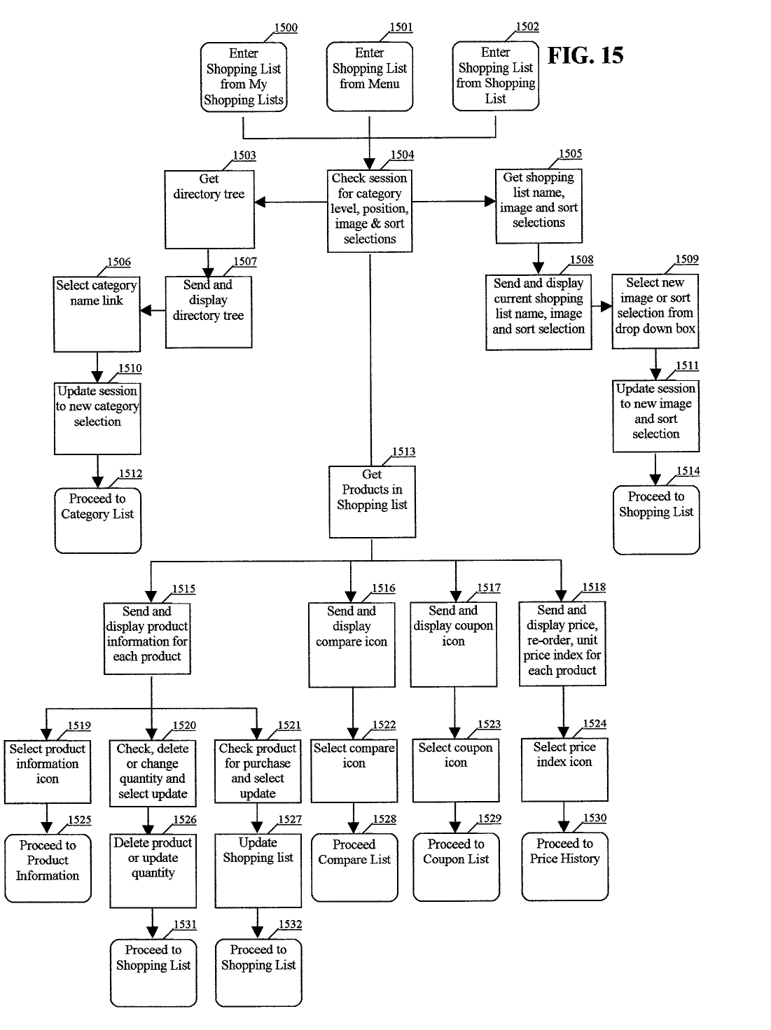

FIG. 15 defines the flow for the Shopping List function. The shopping list function provides the consumer with the ability to list products they purchase frequently and consists of a system defined shopping list for each consumer and consumer defined personal shopping lists. This function allows the consumer to select products for purchase. The shopping list function is entered from My Shopping List function (1500), from the Main Menu (1501) or from itself (Shopping List) (1502). When the client invokes the Shopping List function the server will check the consumer's session to determine current category level, category position, image selection and sort selection (1504).

The server will query the database to get the directory tree (1503), shopping list name, image selections and sort list and selection (1505), and the list of products in the selected shopping list (1513). The server will then send and display the directory tree (1507), category name, image drop down box, sort drop down box (1508), an “Update List” icon and the shopping list products (1515-1518). For each product a delete checkbox, a product info icon, product name, product size, price, select checkbox will be displayed (1515). For each product a compare icon (1516) and coupon icon (1517) will be displayed. For each product a price index icon along with high and low price, a reorder index icon along with days of supply remaining, a unit price icon along with low and high unit prices will be displayed (1518).

If the consumer selects a category name link in the directory tree (1506) then the consumer's session will be update to log the new category selection (1510) and the Category List function will be invoked to display the list of categories (1512). If a new image or sort selection is made (1509) the server will update the session to record these selections (1511) and invoke the shopping list to refresh the display with the new selections (1514). Changing the image selection will display no images, small images or large images for the shopping list products. Changing the sort selection will sort the shopping list products by best buys, price index, re-order index, unit price index, unit price and coupons. If the product info icon is selected (1519) the server will invoke the Product Information function to display detail information on the product (1525). If the delete checkbox and/or quantity are changed and the Update List icon is selected (1520) the server will invoke the Shopping List function to delete the product or update the quantity (1526,1531). If the select checkbox is checked and the Update List icon is selected (1521) the server will invoke the Shopping List function to update the shopping list (1527,1532). Selecting the compare icon (1522) will invoke the Compare List function (1528). Selecting the coupon icon (1523) will invoke the Coupon List function (1529). Selecting the price index icon (1524) will then invoke the price history function that will display a graph of price changes over time for the product (1530).

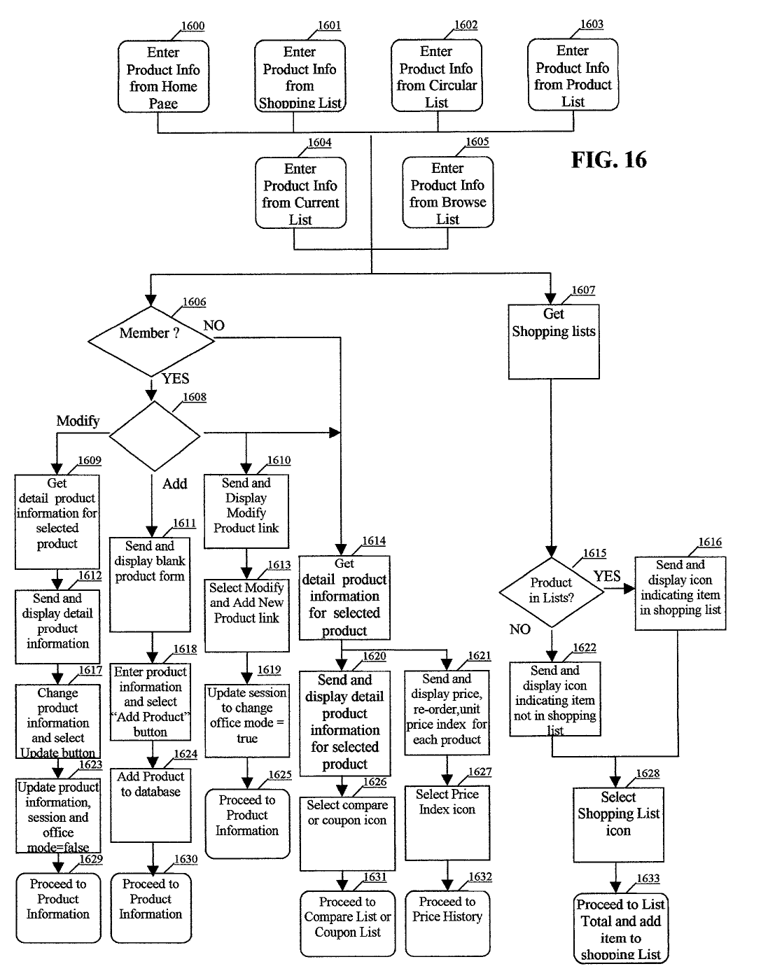

FIG. 16 defines the flow for the Product Information function. This function displays detail product information on the product selected. This function is entered from the Home Page (1600), Shopping List (1601), Circular List (1602), Product List (1603), Current List (1604) and Browse List functions (1605).

The server will query the database to get the consumers shopping list (1607) and will then check to see if the consumer is a member (1606). If the consumer is not a member the server will query the database for detailed product information (1614). The server will then send the detailed product information (1620) and price index along with high and low price, re-order index along with days of supply remaining, unit price index along with high and low unit price to the client (1621). If the consumer is a member the server will then check to see if the “Modify Product” link or “Add New Product” Link was selected (1608). If neither were selected the serve will also query the database for detailed product information (1614). The server will then send and display a “Modify Product” link and “Add New Product Link (1610), detailed product information (1620), price index along with high and low price, re-order index along with days of supply remaining, unit price index along with high and low unit price to the client (1621). If the product is contained in any shopping list (1615) then the server will display an icon indicating that the item is in the list (1616) otherwise it will display an icon indicating it is not in the list (1622).

If the “Modify Product” link is selected (1613) the server will update the session and change office mode to true (1619) and redisplay the product information in text boxes (1625). Changing the product information and selecting the update button (1617) will instruct the server to update the product information in the database, update session and change office mode to false (1623) and re-display the product information without the text boxes. Selecting the compare or coupon icon (1626) will evoke the Compare List or Coupon List (1631) respectively. Selecting the price index icon (1627) will then invoke the price history function that will display a graph of price changes over time for the product (1632). If shopping list icon is selected (1628) the server will invoke the List Total function to add the product to the currently selected shopping list (1633). Both shopping list icons will add the item to the consumers shopping list however the second icon will also select it for purchase.

If “Add Product” link was selected (1613) the server will update the session and change office mode to true (1619) and display a blank product information form (1611). Entering product information and selecting “Add New Product” button (1618) will instruct the server to add the new product to the database (1624).

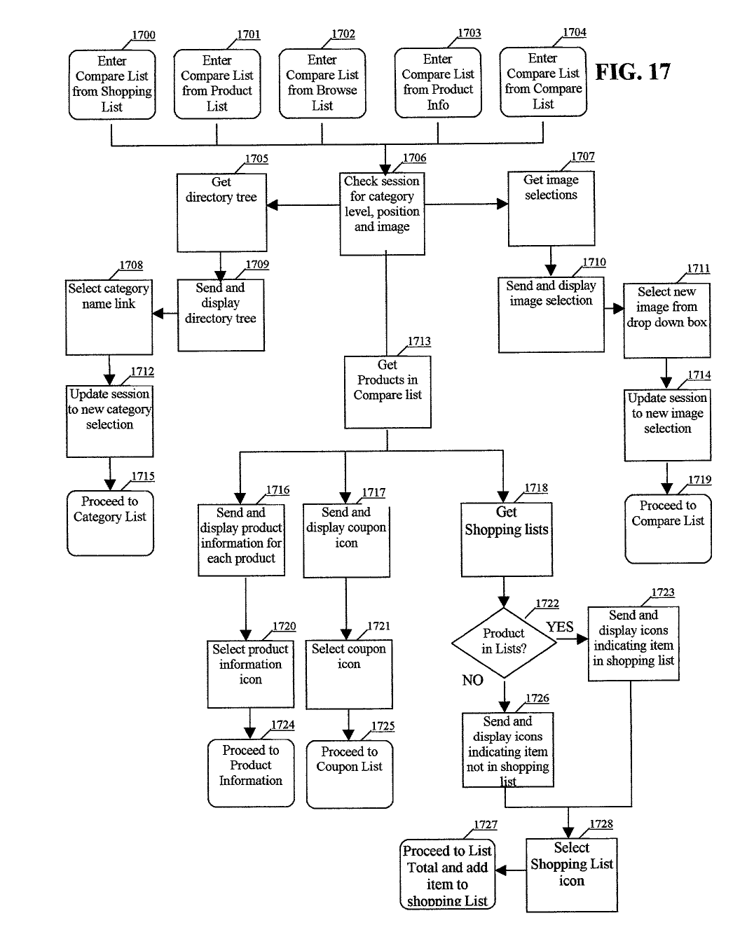

FIG. 17 defines the flow for the Compare List function. The compare list function provides the consumer with the ability to list a small group of similar products in order of unit price and therefore determine products with the lowest unit price. The compare list function is entered from Shopping List function (1700), Product List (1701), Browse List (1702), Product Info (1703) or from itself (Compare List) (1704). When the client invokes the compare list function the server will check the consumer's session to determine current category level, category position, and image selection (1706).

The server will query the database to get the directory tree (1705), image selections (1707), and the list of products in the compare list (1713). The server will then send and display the directory tree (1709), image drop down box (1711) and the compare list products (1716,1717). For each product a product info icon, product name, product size, unit price, high and low unit price, price and shopping list icons will be displayed (1716). For some products the coupon icon will be displayed (1717). If the product is contained in any shopping list (1722) then the server will display an icon indicating that the item is in the list (1723) otherwise it will display an icon indicating it is not in the list (1726).

If the consumer selects a category name link in the directory tree (1708) then the consumer's session will be update to log the new category selection (1712) and the Category List function will be invoked to display the list of categories (1715). If a new image selection is made (1711) the server will update the session to record these selections (1714) and invoke the compare list to refresh the display with the new selections (1719). Changing the image selection will display no images, small images or large images for the shopping list products. If the product info icon is selected (1720) the server will invoke the Product Information function to display detail information on the product (1724). Selecting the coupon icon (1721) will invoke the Coupon List function (1725). If the shopping list icon is selected (1728) the server will invoke the List Total function to add the product to the currently selected shopping list (1727). Both shopping list icons will add the item to the consumers shopping list however the second icon will also select it for purchase.

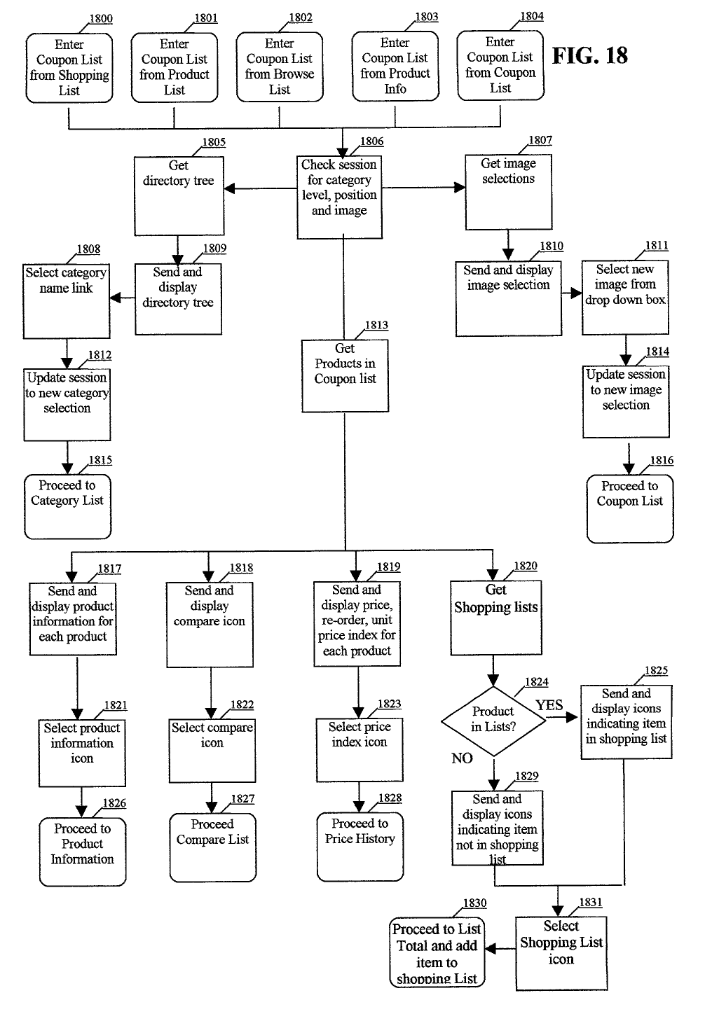

FIG. 18 defines the flow for the Coupon List function. The coupon list function provides the consumer with the ability to view coupon information and list products associated with the coupon. The coupon list function is entered from Shopping List function (1800), Product List (1801), Browse List (1802), Product Info (1803) or from itself (Coupon List) (1804). When the client invokes the compare list function the server will check the consumer's session to determine current category level, category position, and image selection (1806).

The server will query the database to get the directory tree (1805), image selections (1807), and the list of products in the coupon list (1813). The server will then send and display the directory tree (1809), image drop down box (1811) and the coupon list products (1817,1818,1819). For each product a product info icon, product name, product size, unit price, and shopping list icons will be displayed (1817). For some products the compare icon will be displayed (1818). For each of the products a price index icon along with high and low price, a reorder index icon along with days of supply remaining, a unit price index icon along with high and low unit price will be displayed (1819). If the product is contained in any shopping list (1824) then the server will display an icon indicating that the item is in the list (1825) otherwise it will display an icon indicating it is not in the list (1829).

If the consumer selects a category name link in the directory tree (1808) then the consumer's session will be update to log the new category selection (1812) and the Category List function will be invoked to display the list of categories (1815). If a new image selection is made (1811) the server will update the session to record these selections (1814) and invoke the coupon list to refresh the display with the new selections (1816). Changing the image selection will display no images, small images or large images for the shopping list products. If the product info icon is selected (1817) the server will invoke the Product Information function to display detail information on the product (1821). Selecting the compare icon (1822) will invoke the Compare List function (1827). If the price index icon is selected (1823) the server will invoke the Price History function (1828). If the shopping list icon is selected (1831) the server will invoke the List Total function to add the product to the currently selected shopping list (1830). Both shopping list icons will add the item to the consumers shopping list however the second icon will also select it for purchase.

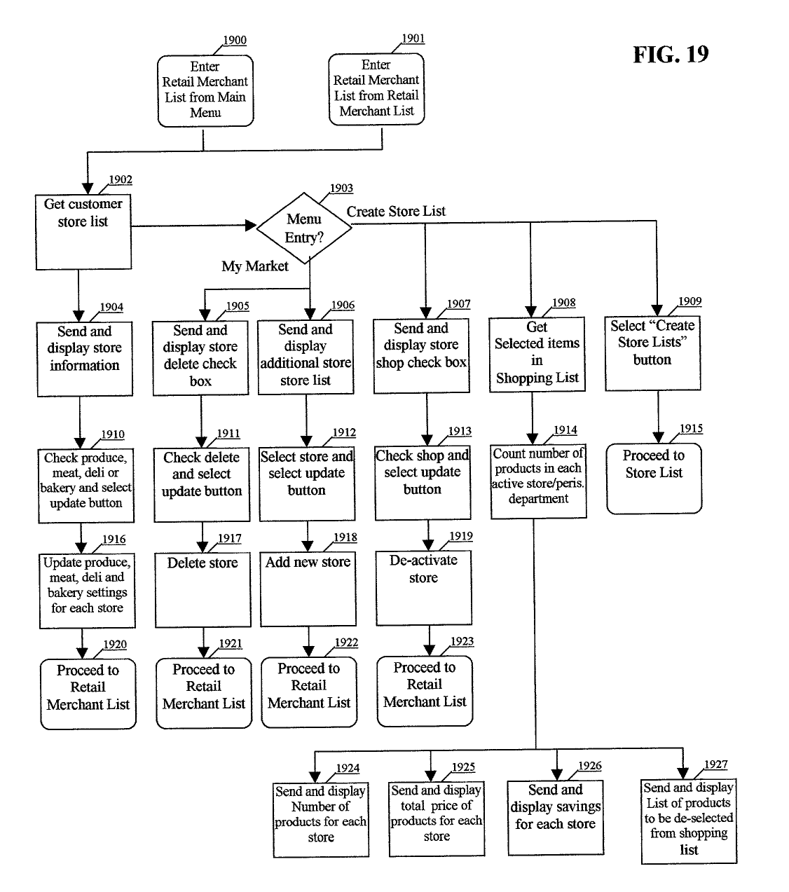

FIG. 19 defines the flow for the Retail Merchant List function. This function displays a list of retail merchant stores that offer the lowest price for products contained in the consumers shopping list and selected for purchase. Each store displays the total quantity of products, total price and total savings that can be realized by purchasing products at these stores. This function is entered from the main menu function (1900) or from itself (1901). When the consumer invokes this function the server will query the database to get a list of stores active for the consumer's market (1902) and then the server will send and display store information including store name, city, state and one checkbox each for produce, deli, meat and bakery (1904). The server will check the menu entry point (1903) and if the menu entry is “My Market” the server will send and display a delete check box (1905) for each active store and also display a list of stores in a drop down box (1906). If the menu entry is “Create Store List” then the server will query the database for the consumers shopping list containing products that have been selected for purchase (1908). For each store the server will display a shop check box (1907) and will calculate (1914) and send the total quantity of products (1924), the total price (1925) and the total savings for each store (1926). The server will also display a “Create Store Lists” button.

If the menu entry is “My Market” the consumer can delete a store by checking the delete check box and selecting the update button (1911,1917). The consumer can add a store by selecting a store from the store list and selecting the update button (1912,1918). The consumer can activate or deactivate one or more perishable departments (Produce, Deli, Meat, and Bakery) within the store by checking or unchecking the check boxes and selecting the update button (1910,1916).

If the menu entry is “Create Store List” then the consumer will have the ability to activate or deactivate any retail merchant store if the consumer prefers not to shop at the store or if the total savings for the store do not warrant the time involved to shop at the store. The consumer will also have the ability to activate or deactivate one or more perishable departments (Produce, Deli, Meat, and Bakery) within the store if the consumer prefers not to purchase these products at a store.

De-activating the store (1913, 1919) or one or more of the departments (1910,1916) and selecting “Update Store Settings” will instruct the server to invoke the Retail Merchant List function to move the products contained within the store or department that was deactivated to the remaining retail merchant stores with the next best lowest price. The server will then re-calculate the product and savings totals and re-display the same store information. Any products moved from the de-activated store or department that are not available in the remaining active stores will be listed (1927) and subsequently removed from the consumers shopping list if the consumer selects the “Create Store Lists” button.

When the consumer selects the “Create Store List” button (1909) the server will invoke the Store List function (1915) and create the store lists.

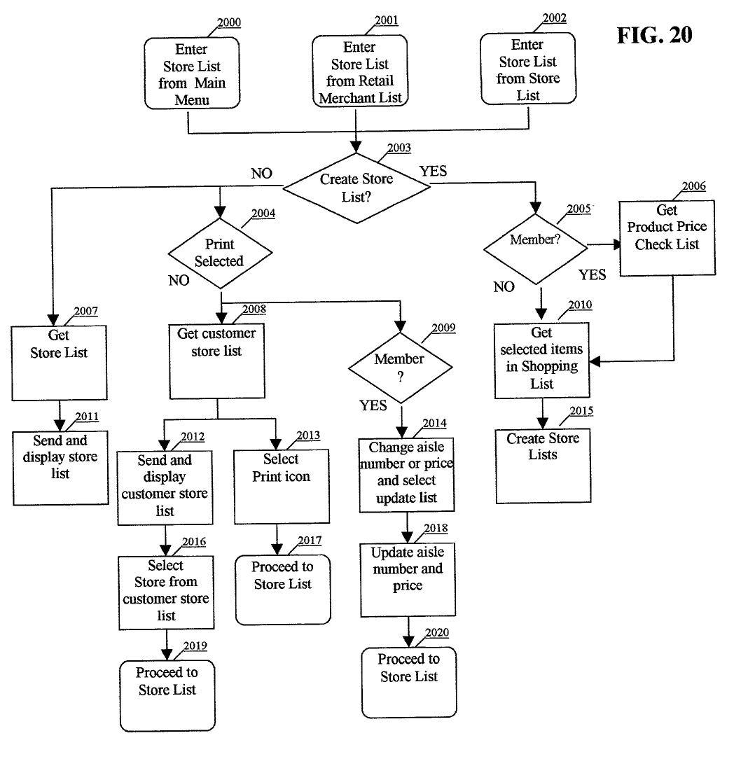

FIG. 20 defines the flow for the Store List function. The Store List function creates the store lists and displays a list of products to be purchased in each retail merchant store. The Store List function can be entered from Main Menu (2000), from Retail Merchant List (2001) or from itself (Store Lists) (2002).

When the consumer invokes this function the server will check to determine if store lists need to be created (2003). If store lists need to be created then the server will then check to see if the consumer is a member (2005). If the consumer is a member then the server will query the database to get the next list of products that require price checking (2006). The server will then query the database to get the items in the consumers shopping list selected for purchase (2010). The server will then create the store lists by combining these two result sets (2015).

The selection of products for price checking is based on products in the consumers shopping list, total consumer purchase rate, price change frequency and the number of days since the last price check. One method for determining the list of products for price checking is to sort products in the weekly shopping list by a price check index for each product calculated as follows:

Price Check Index=(Number of price changes)×(Number of purchases)×(Number of days since last price check)

If store lists are not created then the server will query the database for the most recent store list (2007), send this list to the client (2011) and also check to determine if printing the list has been selected (2004). If printing the list has not been selected then the server will query the database for the consumer's list of retail stores (2008), send and display the list of retail stores (2012) and check if the consumer is a member (2009). If the consumer is a member the server will allow editing of the store list information.

The server will display the list of stores in a drop down box including an “All Stores” entry that is the default entry and display a “Print This” and “Update List” icons. The server will then display the first retail merchant store name, the first aisle number and description and then list the products within the aisle. This will be repeated until all aisles within the store have been displayed. This procedure will then be repeated for each retail merchant store. Each product listed will display the name of the product, the size and quantity. If the consumer is a member the products that require price checking will also be displayed in the appropriate aisle for each retail merchant store. If the consumer is a member all products will display the aisle number, price in a text box and “price check” and “not available” check boxes allowing the member to update this information.

Selecting a specific store from the store drop down box (2016) will instruct the server to send and display only the products for the store selected. Selecting the “Print This” icon (2013) will re-display the information removing the store drop down box and “Print This” icon so the consumer can then print the store list. The consumer can print one Store list with all stores listed or print a list for each store. If the consumer is a member changing the aisle number, price and “price check” and “not available” check boxes and selecting the “Update” icon (2014) will instruct the server to update this information in the database (2018).

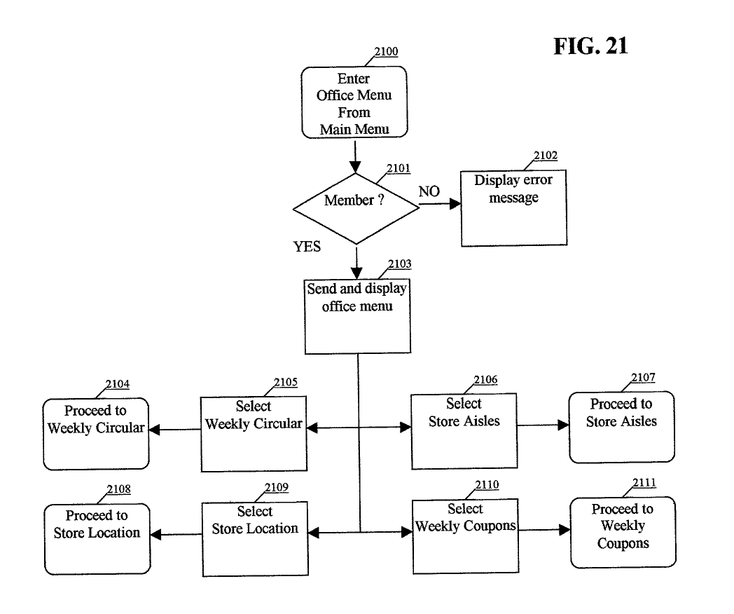

FIG. 21 defines the flow for the Office Menu function The Office Menu function displays the menu of options for consumers who are also members. The Office Menu is entered from the Main Menu only (2100). When the member invokes this function the server will first check to make sure the consumer is a member (2101). If the consumer is not a member then an error message will be displayed (2102). If the consumer is a member then the server will display a list of Office Menu links (2103). Selecting the Weekly Circular link (2105) will invoke the Weekly Circular function (2104) and allow the member to update product prices based on each retail merchants weekly advertised prices. Selecting the Store Aisle link (2106) will invoke the Store Aisle function (2107) that will allow the member to add, update or delete retail merchant's store aisle list. Selecting the Store Location link (2109) will invoke the Store Location function (2108) that will allow the member to add, update or delete store aisle location information for each department within each retail merchant's store. Selecting the Weekly Coupons link (2110) will invoke the Weekly Coupons function (2111) that will allow the member to add weekly coupon offers.

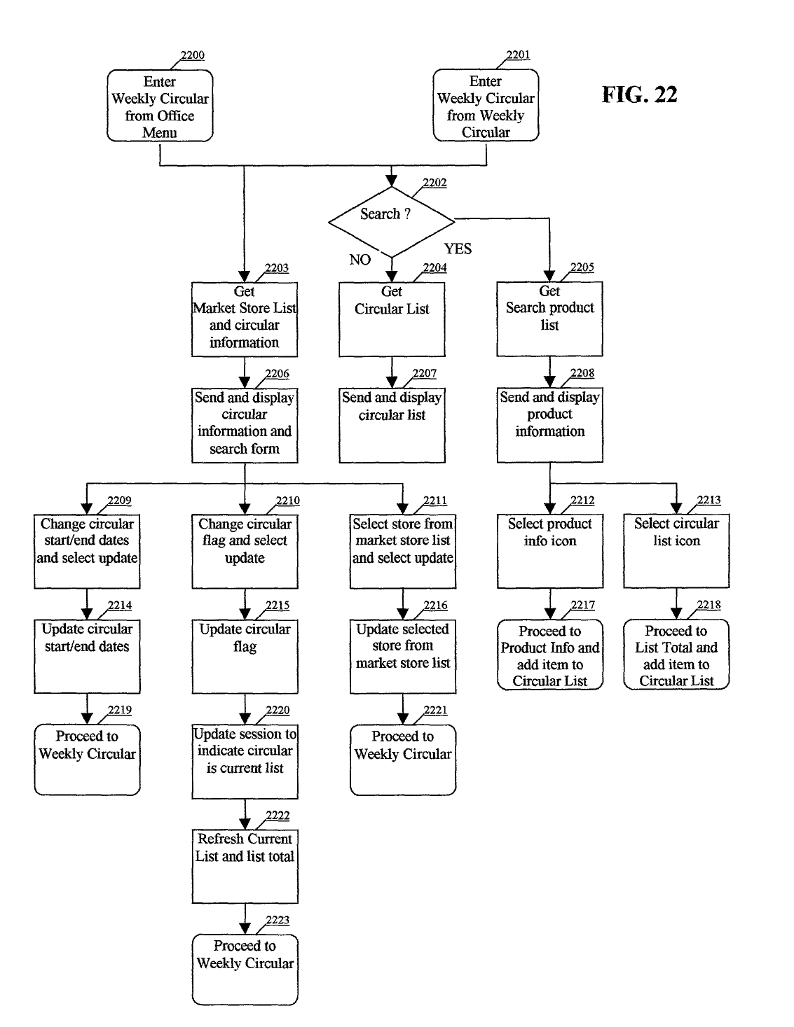

FIG. 22 defines the flow for the Weekly Circular function. This function allows the consumer to update pricing in the database based on each retail merchant's weekly-advertised prices. The Office Menu (2200) and itself (Weekly Circular) (2201) can enter the Weekly Circular. When the member invokes this function the server will query the database for the list of stores in the market, the circular start and end dates and any active circular lists (2203). When the current date is between the start and end circular effective dates then the list is active. The server will then send and display a circular check box, a store list drop down box, a circular start date, a circular end date, an update button and a search form

The server will then check to see if a search has been initiated (2202). If a search has not been initiated then the server will query the database for any circular lists (2204). The server will then send and display the circular list at the client (2207). Each circular list will be preceded by the circular effective date and each product within the circular list will display the product name, product size, unit price and price. If a search has been initiated then the server will query the database for a list of products matching the search criteria (2205). The server will then send and display the product information (2208).

Selecting a new store from the store list and selecting the update button (2211) will instruct the server to get, send and display circular information for the new store (2216). Selecting the circular check box and selecting the update button (2210) will instruct the server to update the member's session, change the circular mode to true and make the circular list the current list (2220). The server will also refresh the Current List and List Total functions (2222) and redisplay the Weekly Circular information (2223). Changing the circular start and end dates (2209) will update the database to reflect the new start and end dates (2214) so any products that are subsequently added to the circular list will have the new price become effective during the new start and end dates.

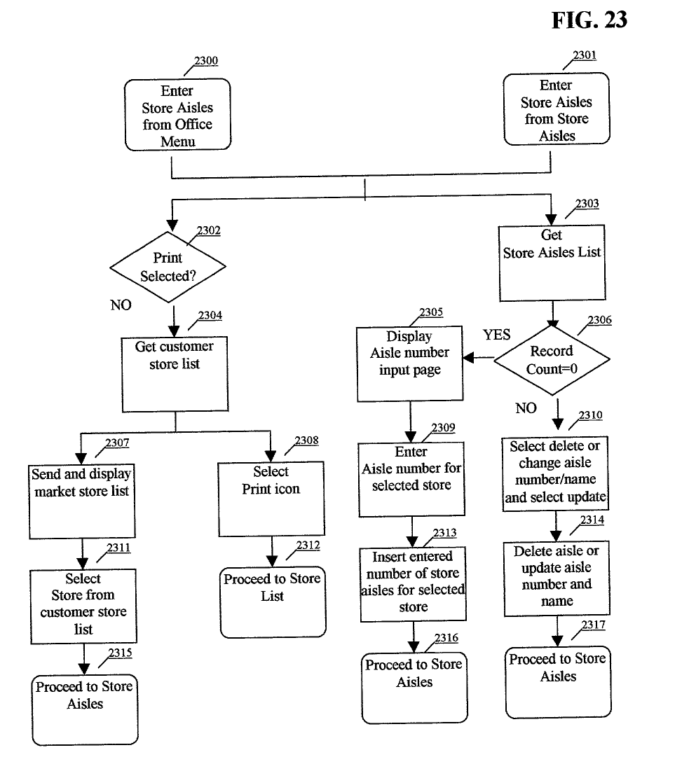

FIG. 23 defines the flow for the Store Aisles function. This function allows the member to add, update, delete and display or print a list of store aisles for each retail merchant's store. This function can be entered from the Office menu (2300) or itself (Store Aisles) (2301). When the member invokes this function the server will query the database to get a list of retail merchant stores (2304) in the market and the list of store aisles (2303).

The server will then send and display the store list in a drop down box (2307), a “Print This” and Update icons, and the list of store aisles. For each store aisle a delete checkbox, an aisle number text box, an aisle position text box and an aisle description text box will be displayed. If no store aisles have been defined for this store, an aisle number input page will be sent and displayed (2305).

If no aisles exist and the member enters an aisle number quantity (2309) and selects the “Go” icon the server will add an entry up to the aisle quantity specified (2313). The server will then re-display the Store Aisles information where the information for each store aisle is blank (2316). Selecting a new store from the drop down box (2311) will instruct the server to re-display the aisle information for this new store (2315). Selecting the delete check box or entering aisle information and selecting the “Update List” icon (2310) will instruct the server to delete or update the aisle information (2314) and re-display the Store aisle information (2317). Selecting the “Print This” icon (2308) will instruct the server to display the store aisle information (2312) without the store list drop down box or “Print This” and “Update List” icons allowing the member to print the list.

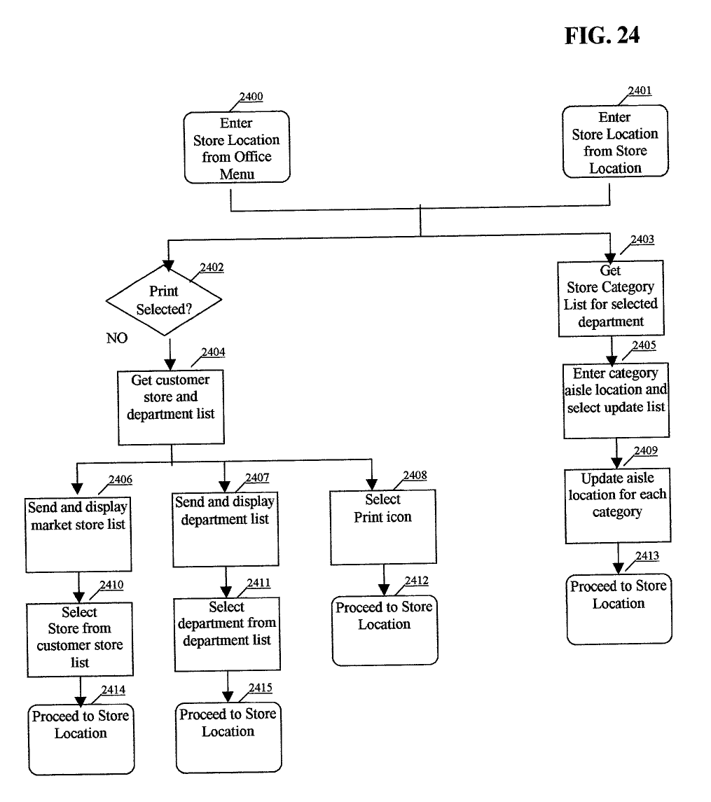

FIG. 24 defines the flow for the Store Location function. This function allows the member to update, display or print a list of store locations for each department within each retail merchant's store. This function can be entered from the Office menu (2400) or itself (Store Aisles) (2401). When the member invokes this function the server will query the database to get a list of retail merchant stores in the market, the list of departments within the store (2404) and the list of store locations for each department (2403).

The server will then send and display the store list in a drop down box (2406), the department list in a drop down box (2407), a “Print This” and Update icons, and the list of store department locations (2403). For each store department location an aisle number, aisle position and product position text box will be displayed.

Selecting a new store from the drop down box (2410) will instruct the server to re-display the store location information for this new store (2414). Selecting a new department within the store (2411) will instruct the server to re-display the store location information for this new department (2415). Entering aisle information and selecting the “Update List” icon (2405) will instruct the server to update the store department location information (2409) and redisplay the Store Location information (2413). Selecting the “Print This” icon (2408) will instruct the server to display the store department location information without the store list drop down box, the department list drop down box, or “Print This” and “Update List” icons allowing the member to print the list.

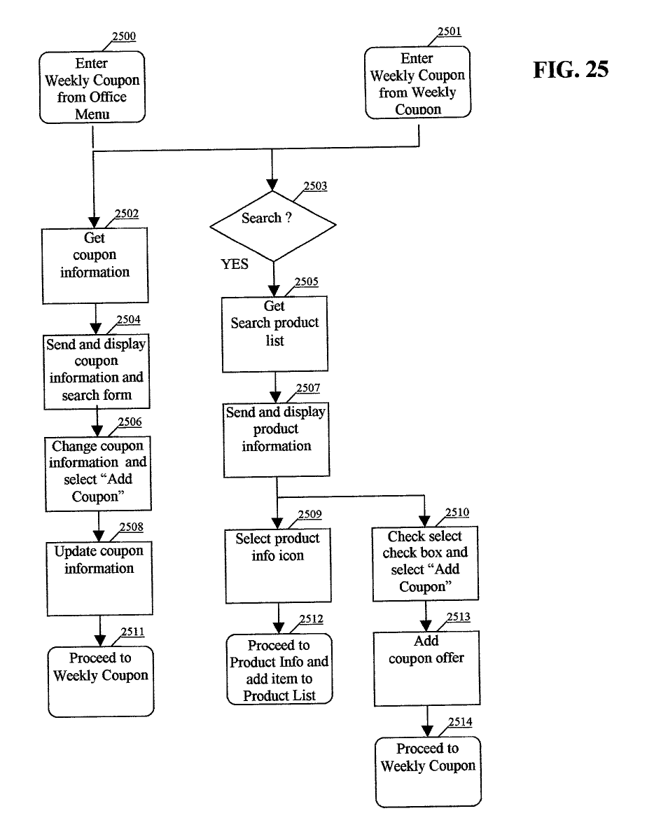

FIG. 25 defines the flow for the Weekly Coupon function. This function allows the consumer add coupon offers. The Office Menu (2500) and itself (Weekly Coupon) (2501) can enter the Weekly Coupon function. When the member invokes this function the server will send and display coupon information (2502) consisting of a coupon start date, a coupon end date, a coupon description, coupon value, coupon quantity, coupon location, an “Add Coupon” button and a search form (2504).

The server will then check to see if a search has been initiated (2503). If a search has been initiated then the server will query the database for a list of products matching the search criteria (2505). The server will then send and display the product information (2507). Each product includes a product info icon, product name, size, price and a select check box.

Inserting or changing the coupon information and selecting “Add Coupon” (2508) will update the coupon information (2508). Selecting the product info icon (2509) will invoke the Product Info function (2512) and add a new product. Checking the select checkbox for one or more products and selecting the “Add Coupon” (2510) button will add a coupon offer.

1. A method for a cooperative consumer electronic shopping and pricing system that provides consumers with buying information and purchase recommendations for products when retail prices are at their lowest relative point and prior to when consumer demand for the product exists.

2. The method of claim 1, which further comprises the steps of:
a) Logging in a consumer.
b) Transmitting and displaying a plurality of product information including the lowest retail price available for each product offered by a plurality of retail merchants in each market and sorting this information in order of recommended purchase.
c) Receiving product search requests from the consumer and transmitting back and displaying a resulting plurality of products.
d) Receiving product department and category selections from the consumer and transmitting back and displaying a resulting plurality of products.
e) Receiving product selections from the consumer that consist of a plurality of regularly purchased products and transmitting back and displaying this list of products sorted in order of recommended purchase.
f) Receiving product selections from the consumer that consists of a plurality of products selected by the consumer for purchase and transmitting back and displaying this list of products.
g) Transmitting and displaying the list of products selected for purchase sorted by each retail merchant available in the market listing the total products recommended to be purchased at this retail store and the total savings that can be realized by purchasing these products at this retail store.
h) Receiving requests from the consumer to temporarily de-activate retail merchants whereby products are then automatically moved to the remaining active retail merchants based on the next lowest price for each product and transmitting back and displaying this information.
i) Receiving a request from the consumer to create store shopping lists whereby the plurality of products in the list of products selected for purchase are sorted by each retail merchant and transmitted back to the consumer and displayed.

3. The method of claim 1, which further comprises a method that creates, stores and displays a price index for each product within a plurality of products from a plurality of retail merchants. Where the price index provides an indication of how the current lowest price available from a plurality of retail merchants compares with the high and low prices recorded for this product over a defined period of time.

4. The method of claim 1, which further comprises a method that creates, stores and displays a price history for each product within a plurality of products from a plurality of retail merchants. Where the price history provides a graphical indication of the price levels over a defined period of time.

5. The method of claim 1, which further comprises a method that creates, stores and displays a personalized re-order index for each product within a plurality of products for each consumer. Where the re-order index provides an indication of how much time is remaining before the consumer will need to purchase the product.

6. The method of claim 1, which further comprises a method that creates, stores and displays a unit price index for each product within a plurality of products from a plurality of retail merchants. Where the unit price index provides an indication of how the current unit price compares with the unit prices of a group of similar products.

7. The method of claim 1, which further comprises a method where a plurality of products for each registered consumer are recommended for purchase based on the pre-defined regularly purchased list of products, price index, re-order index and unit price index information.

8. The method of claim 1, which further comprises a method where a plurality of products in a plurality of product categories are recommended for purchase based on the pre-defined regularly purchased list of products, price index, re-order index and unit price index information.

9. The method of claim 1, which further comprises a method to create and display a list of retail merchant stores that offer the lowest price for products contained in the consumers shopping list that were selected for purchase where each store displays the total quantity of products, total price and total savings that can be realized by purchasing products at these stores.

10. The method of claim 9, which further comprises a method to temporarily de-activate retail merchants and departments from the temporary list of products sorted by each retail merchant whereby products are then moved to the remaining active retail merchants based on the next lowest price for each product.

11. An apparatus for a cooperative consumer electronic shopping and pricing system that provides consumers with buying information and purchase recommendations for products when retail prices are at their lowest relative point and prior to when consumer demand for the product exists.

12. The apparatus of claim 11, which further comprises:
a) A communications network establishing two-way communication between a central site and each of a plurality of consumer computers.
b) A computer located at a central site, the computer including
i) A means for storing a plurality of customer information, a plurality of product information, a plurality of product department and category information, a plurality of pricing information for a plurality of retail merchants in a plurality of markets, a plurality of regularly purchased products, a plurality of products selected for purchase and a means for storing a plurality of store shopping lists.
ii) Means for transmitting product information to each of the consumer's computers.
iii) Means for receiving search requests from each of the consumer's computers and transmitting a resulting plurality of products to each of the consumer's computers.
iv) Means for receiving product department and category selections from the consumer and transmitting a resulting plurality of products to each of the consumer's computers.
v) Means for receiving product selections from the consumer that consist of a plurality of regularly purchased products and transmitting this list of products sorted in order of recommended purchase to each of the consumer's computers.
vi) Means for receiving product selections from the consumer that consists of a plurality of products selected for purchase and transmitting this list of products to each of the consumer's computers.
vii) Means for transmitting the list of products selected for purchase sorted by each retail merchant available in the market listing the total products recommended to be purchased at this retail store and the total savings that can be realized by purchasing these products at this retail store to each of the consumer's computers.
viii) Means for receiving requests from the consumer to temporarily de-activate retail merchants and move products to the remaining active retail merchants based on the next lowest price for each product and transmitting this information to each of the consumer's computers.
ix) Means for receiving a request from the consumer to create store shopping lists whereby the plurality of products in the list of products selected for purchase are sorted by each retail merchant and transmitting this information to each of the consumer's computers.
c) A computer located at a each consumer, the computer including
i) Means for displaying product information.
ii) Means for sending search requests to the central computer, receiving and displaying a resulting plurality of products from the central computer.
iii) Means for sending product department and category selections to the central computer and receiving and displaying a resulting plurality of products from the central computer.
iv) Means for sending regularly purchased product selections to the central computer and receiving and displaying this list of products sorted in order of recommended purchase from the central computer.
v) Means for sending product selections for purchase to the central computer and receiving this list of products from the central computer.
vi) Means for receiving and displaying the list of products selected for purchase sorted by each retail merchant in the market from the central computer.
vii) Means for sending requests to temporarily de-activate retail merchants to the central computer and receiving and displaying the revised retail merchant list from the central computer.
viii) Means for sending a request to create store shopping lists to the central computer and receiving and displaying the store shopping lists from the central computer.

13. A method for a cooperative consumer electronic shopping and pricing system that provides consumers who are also members with the ability to input pricing information on products and share this pricing information with the larger consumer population.

14. The method of claim 13, which further comprises the steps of:
a) Logging in a consumer as a member.
b) Receiving a request from the member to create store-shopping lists whereby a plurality of products that require price checks are included in the store shopping lists and transmitted back and displayed. Where selection of the products that require price checks are based on previous price check date, product order frequency and price change frequency. Where the consumer will check prices and store location during their regular shopping trip.
c) Receiving product price and location changes from members for a plurality of products that require price checking and transmitting back and displaying the changed store lists.
d) Receiving product price updates from members for a plurality of products based on prices advertised by retail merchants.
